(19) United States
(12) Patent Application Publication
(10) Pub. No.: US 2011/0239286 A1
(43) Pub. Date: Sep. 29, 2011

(54) MOBILE COMMUNICATIONS TERMINAL AUTHENTICATION AND SETTLEMENT SYSTEM AND METHOD

(75) Inventor: Yoshifumi Hiraide, Tokyo (JP)

(73) Assignee: SHINTEN SANGYO CO., LTD., Tokyo (JP)

(21) Appl. No.: 12/958,333

(22) Filed: Dec. 1, 2010

(30) Foreign Application Priority Data
Mar. 29, 2010 (JP) 2010-093500

(51) Int. Cl. G06F 21/20

(52) U.S. Cl. 726/7

(57) ABSTRACT

To authenticate fingerprint information detected by a mobile communications terminal at a fingerprint registration depot provided on the Internet, to thereby perform appropriate and reliable electronic authentication and electronic settlement, in a mobile communications terminal authentication and settlement system in which a mobile communications terminal accesses various websites on the Internet to perform electronic authentication and electronic settlement, the mobile communications terminal includes an operation panel that can be used in common for a fingerprint sensor mode and a touch panel mode. On the Internet, there is provided a fingerprint registration depot, to which the mobile communications terminal is connected and at which detected fingerprint information is compared with fingerprint authentication information registered in advance, to thereby perform fingerprint authentication. The mobile communications terminal is authorized to access the various websites via the Internet when authentication is successfully performed at the fingerprint registration depot.

### CROSS-REFERENCE TO RELATED APPLICATIONS

The present patent application claims priority from Japanese Patent Application No. 2010-093500, filed on Mar. 29, 2010, which is hereby incorporated herein by reference in its entirety.

### BACKGROUND OF THE INVENTION

1. Field of the Invention

The present invention relates to an authentication and settlement system for a mobile communications terminal with fingerprint sensor, which has a fingerprint sensor integrated therein, and also relates to an authentication and settlement method therefor.

2. Description of the Related Art

There has been developed a mobile communications terminal such as a mobile phone terminal which is equipped with a fingerprint sensor, and for the purpose of security of a mobile phone terminal and other such device, there have conventionally been proposed various devices that employ fingerprint authentication to unlock the device for use.

For example, the mobile phone terminal has the fingerprint sensor exposed in a part of its casing. When an operator touches a sensor surface of the fingerprint sensor with his/her finger or moves his/her finger while touching the sensor surface, the fingerprint sensor reads a fingerprint of the finger, and based on fingerprint detection information obtained by the reading, fingerprint authentication is performed (see, for example, Japanese Patent Application Laid-open Nos. 2008-5147 and 2007-82139).

The fingerprint authentication described above is generally performed by comparing the above-mentioned fingerprint detection information with fingerprint authentication information that is stored in the terminal in advance, and by determining whether or not there is a match between the two pieces of information. The fingerprint authentication allows the owner to use his/her mobile communications terminal and forbids other persons than the owner to use the mobile communications terminal.

By the way, what is demanded of the above-mentioned mobile communications terminal such as the mobile phone terminal is to prevent unauthorized use of the mobile communications terminal by other persons than the owner, to thereby ensure a security function. In addition, for example, there is a demand for electronic authentication and electronic settlement at the time of accessing various websites via the Internet.

In the case of using this type of mobile communications terminal to access various websites on the Internet, problems with security and operability may inhere in the electronic authentication and the electronic settlement at the time of accessing the respective websites. In particular, the above-mentioned electronic authentication and electronic settlement require processing of typing an ID, a password, and the like, and skipping such processing may lead to the problem with security. Therefore, there is a demand for appropriate and reliable electronic authentication and electronic settlement which may be performed through a simpler operation.

### SUMMARY OF THE INVENTION

The present invention has been made in view of the above-mentioned circumstances, and therefore the present invention has an object to provide a mobile communications terminal authentication and settlement system and an authentication and settlement method therefor, in which fingerprint information detected by a mobile communications terminal is authenticated at a fingerprint registration depot provided on the Internet, to thereby perform appropriate and reliable electronic authentication and electronic settlement, to prevent unauthorized use of the terminal, and to provide excellent operability.

In order to achieve the above-mentioned object, the present invention (invention according to claim 1) provides a mobile communications terminal authentication and settlement system in which a mobile communications terminal accesses various websites on an Internet to perform electronic authentication and electronic settlement, the mobile communications terminal including: an operation panel that can be used in common for a fingerprint sensor mode and a touch panel mode; and external signal transmission means for transmitting fingerprint information detected by the operation panel to an outside, the mobile communications terminal authentication and settlement system including a fingerprint registration depot, to which the mobile communications terminal is connected via the Internet and at which the fingerprint information is compared with fingerprint registration information registered in advance, to thereby perform fingerprint authentication, in which the mobile communications terminal is authorized to access the various websites via the Internet when the fingerprint authentication is successfully performed at the fingerprint registration depot.

According to the present invention (invention according to claim 2), in the mobile communications terminal authentication and settlement system according to claim 1, the operation panel has a function as a fingerprint sensor, to thereby detect, on a surface of the fingerprint sensor, one of motion of a fingertip and a change in point of applied pressure, and the operation panel causes one of a cursor and a pointer to move on a display of the mobile communications terminal based on information obtained by the detecting.

The present invention (invention according to claim 3) provides an authentication and settlement method for an authentication and settlement system in which a mobile communications terminal accesses various websites on an Internet to perform electronic authentication and electronic settlement, the mobile communications terminal including an operation panel that can be used in common for a fingerprint sensor mode and a touch panel mode, the authentication and settlement system including a fingerprint registration depot at which fingerprint information detected by the operation panel is compared with fingerprint registration information registered in advance, to thereby perform fingerprint authentication, the authentication and settlement method including: connecting the mobile communications terminal to the fingerprint registration depot via the Internet by using the operation panel of the mobile communications terminal in the touch panel mode; transmitting, to the fingerprint registration depot, the fingerprint information detected by touching the operation panel with a finger; comparing the fingerprint information with the fingerprint registration information registered in advance at the fingerprint registration depot; and performing the fingerprint authentication through the comparing, to thereby perform the electronic authentication and the electronic settlement.

As described above, according to the mobile communications terminal authentication and settlement system and the authentication and settlement method therefor of the present invention, various good effects are produced by providing the operation panel to the mobile communications terminal, which can be used in common for the fingerprint sensor mode and the touch panel mode, and the fingerprint registration depot at which the fingerprint information detected by the operation panel is compared with the fingerprint registration information registered in advance, to thereby perform the fingerprint authentication. That is, by performing matching and authentication processing for the fingerprint information detected by the mobile communications terminal at the fingerprint registration depot provided on the Internet, appropriate and reliable electronic authentication and electronic settlement can be performed, unauthorized use of the terminal is prevented, and operability is excellent, despite the simple configuration.

### BRIEF DESCRIPTION OF THE DRAWINGS

In the accompanying drawings:

FIG. 1 is a schematic configuration diagram of a communications network representing an authentication and settlement system using a mobile communications terminal (mobile phone terminal) with fingerprint sensor according to one embodiment of the present invention;

FIG. 2 is an explanatory diagram of registration of a fingerprint in a fingerprint registration depot from the mobile communications terminal (mobile phone terminal) with fingerprint sensor;

FIG. 3 is an explanatory diagram of an operation of the mobile communications terminal (mobile phone terminal) with fingerprint sensor;

FIG. 4A is an explanatory diagram of a procedure of registering fingerprint information at the fingerprint registration depot;

FIG. 4B is an explanatory diagram of a procedure of authenticating the fingerprint information at the fingerprint registration depot; and

FIG. 5 is an explanatory diagram of a procedure of electronic authentication and electronic settlement at the fingerprint registration depot.

### DETAILED DESCRIPTION OF THE PREFERRED EMBODIMENT

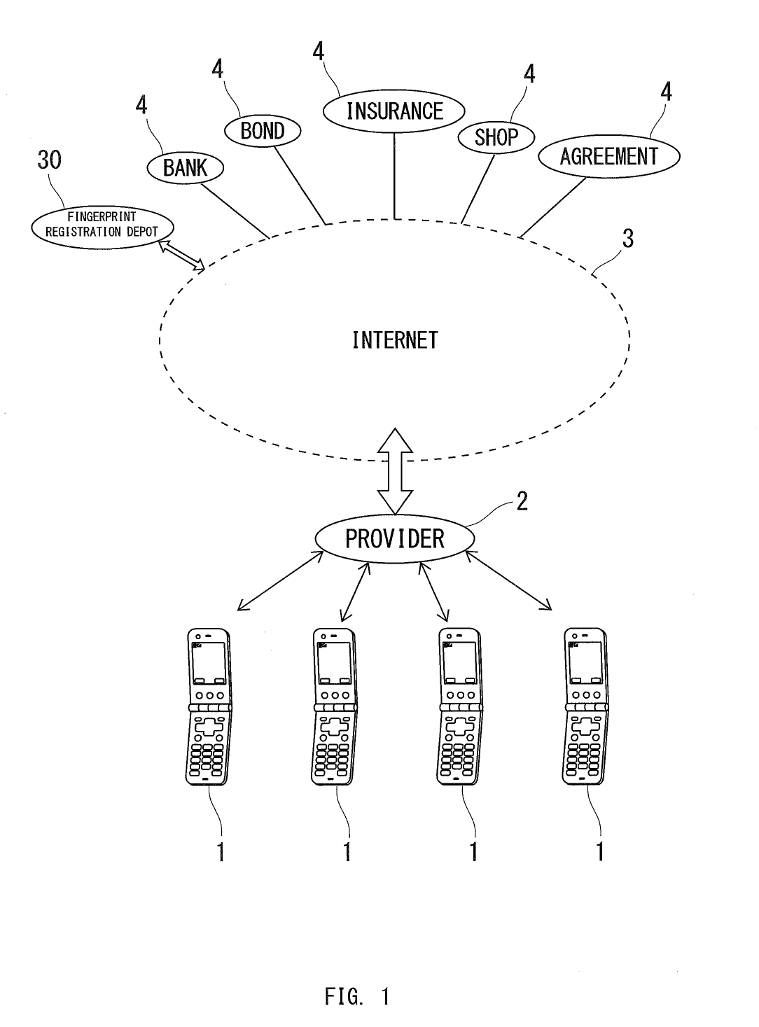

FIGS. 1 to 4B illustrate a mobile communications terminal authentication and settlement system and an authentication and settlement method therefor according to an embodiment of the present invention.

Regarding FIGS. 1 to 4B, reference numeral 1 represents a mobile phone terminal as a mobile communications terminal. The mobile phone terminal 1 is connected to an Internet 3 by a provider 2 as appropriate, and can access various websites 4 via the Internet 3.

As is well known, the various websites 4 are provided for a variety of purposes, but access to the websites 4 herein involves electronic authentication and electronic settlement. Examples of the websites 4 herein include websites of a bank, a securities company, an insurance company, and a shop.

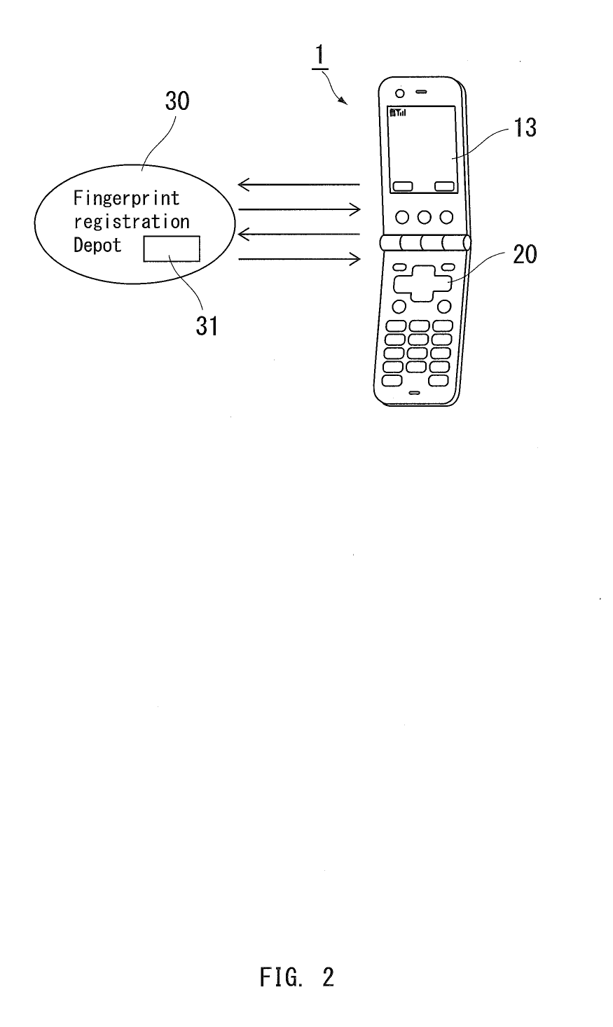

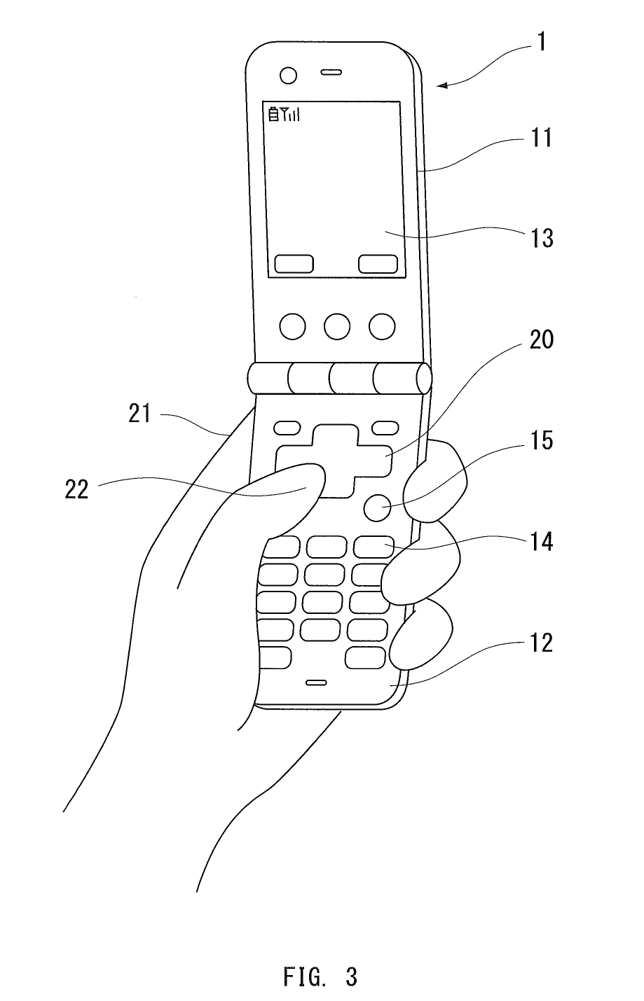

According to this embodiment, as illustrated in FIGS. 2 and 3, the exemplified mobile phone terminal 1 as the mobile communications terminal is a flip mobile phone terminal including an upper casing 11 and a lower casing 12.

In this case, the upper casing 11 is provided with a display 13 for performing various kinds of display, and other components. Further, the lower casing 12 is provided with operation buttons 14 such as numeric keys, mode switching buttons 15, and other components on an operation surface of the lower casing 12.

The mobile phone terminal 1 of the present invention includes an operation panel 20 in a part of the lower casing 12. The operation panel 20 has a function as a fingerprint sensor, which detects a fingerprint when an operator holds the terminal 1 with his/her hand 21 and touches the sensor surface with his/her thumb 22. The operation panel 20 also has a function as a touch panel. Specifically, the operation panel 20 detects, on the sensor surface, motion of a fingertip or a change in point of applied pressure, and causes a cursor or pointer (not shown) to move on the display 13 of the mobile communications terminal 1 based on the resultant detection information.

Further, according to the present invention, the above-mentioned operation panel 20 having the functions as a fingerprint sensor and a touch panel can be used in common for a fingerprint sensor mode and a touch panel mode.

Note that, the mobile communications terminal 1 has various functions that are necessary to serve as a CPU and external signal transmission means for transmitting fingerprint information detected by the operation panel 20 to the outside, and to serve as the mobile communications terminal 1.

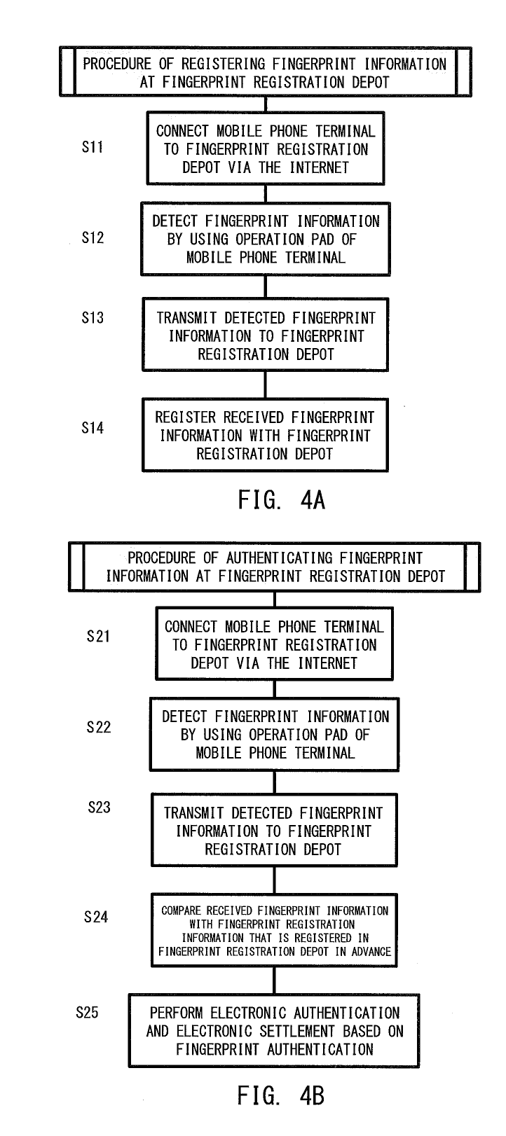

Further, according to the present invention, there is provided a fingerprint registration depot 30, to which the mobile communications terminal 1 is connected via the Internet 3 and at which the detected fingerprint information is compared with fingerprint registration information registered in advance, to thereby perform fingerprint authentication. Then, when the authentication is successfully performed at the fingerprint registration depot 30 as described in S21 to S25 of FIG. 4B, the mobile communications terminal 1 is authorized to access the various websites 4 via the Internet 3. Accordingly, the mobile communications terminal 1 accesses the various websites 4 on the Internet 3 to perform electronic authentication and electronic settlement.

Note that, registration of the fingerprint information with the fingerprint registration depot 30 is performed as appropriate by following, for example, a procedure described in S11 to S14 of FIG. 4A.

Further, in FIG. 2, reference numeral 31 represents a security system provided at the fingerprint registration depot 30.

According to the authentication and settlement system having the above-mentioned configuration, in order for the mobile communications terminal 1 to access the various websites 4 on the Internet 3 to perform electronic authentication and electronic settlement, it is necessary to register the fingerprint registration information with the fingerprint registration depot 30 in advance by using the operation panel 20 that is provided to the mobile communications terminal 1 and can be used in common for the fingerprint sensor mode and the touch panel mode.

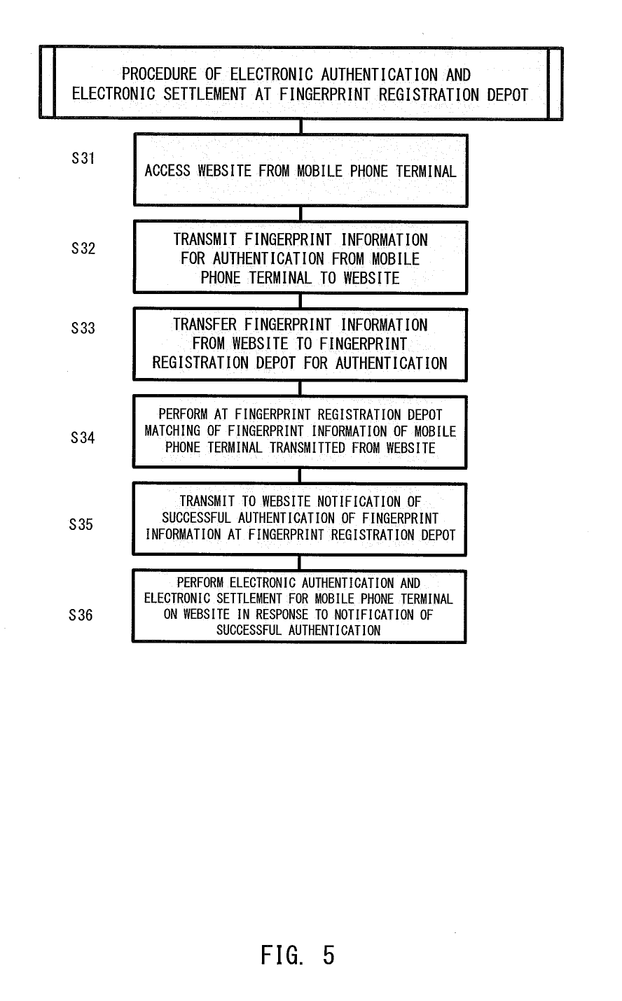

Under the condition described above, as described in S31 to S36 of FIG. 5, the mobile communications terminal 1 is connected to the fingerprint registration depot 30 via the Internet 3 by using the operation panel 20 of the mobile communications terminal 1 in the touch panel mode. Further, the fingerprint information detected by touching the operation panel 20 with the thumb 22 or other finger is transmitted to the fingerprint registration depot 30.

Then, at the fingerprint registration depot 30, the received fingerprint information is compared with the fingerprint registration information registered in advance, and it is determined whether or not there is a match between the two pieces of information. Then, it is determined whether or not to authorize the access from the mobile phone terminal 1, and the resultant determination information is transmitted.

According to the authentication and settlement system described above, in the case where each website 4 is accessed from the mobile phone terminal 1 and electronic authentication and electronic settlement are requested, the website 4 transmits, to the fingerprint registration depot 30, the fingerprint information that is transmitted from the mobile phone terminal 1, and receives the determination information on the fingerprint information, to thereby enable the determination of whether or not the user of the mobile phone terminal 1 is an authorized user, and to enable the electronic authentication and the electronic settlement.

Thus, it is possible to perform more reliable authentication and settlement as compared with the conventional authentication and settlement using only an ID and a password, resulting in excellent security.

Needless to say, the fingerprint registration depot 30 may also be used for the conventionally known purpose of preventing unauthorized use of the mobile phone terminal 1.

Note that, the present invention is not limited to the configuration described in the above-mentioned embodiment, and it goes without saying that modifications and changes may be made as appropriate to the shapes of the components constituting the authentication and settlement system using the mobile communications terminal 1, the configuration thereof, and the like.

For example, the fingerprint sensor constituting the operation panel 20 is not limited to a pressure sensitive sensor, various types of which have been known heretofore, and a sensor having a different structure may be employed therefor.

What is important is that the sensor can obtain the fingerprint information through detection.

Further, the fingerprint information transmitted from the above-mentioned mobile phone terminal 1 or the like is not limited to information obtained by scanning the fingerprint itself, and the fingerprint information may be obtained by extracting only main points of the fingerprint, or alternatively, may be simplified information obtained by encoding and modeling the main points of the fingerprint. Such simplification of information reduces the amount of communication in the authentication and the like, which leads to high-speed authentication.

Although the present invention has been described with reference to specific embodiments, it is to be understood that the invention is not limited to such disclosed embodiments but encompasses all modifications, improvements, and equivalent structures and functions. It is therefore to be understood that, within the scope of the appended claims, the present invention may be practiced otherwise than as described herein.

What is claimed is:

1. A mobile communications terminal authentication and settlement system in which a mobile communications terminal accesses various websites on an Internet to perform electronic authentication and electronic settlement,
the mobile communications terminal comprising:
an operation panel that can be used in common for a fingerprint sensor mode and a touch panel mode; and
external signal transmission means for transmitting fingerprint information detected by the operation panel to an outside,
the mobile communications terminal authentication and settlement system comprising a fingerprint registration depot, to which the mobile communications terminal is connected via the Internet and at which the fingerprint information is compared with fingerprint registration information registered in advance, to thereby perform fingerprint authentication,
wherein the mobile communications terminal is authorized to access the various websites via the Internet when the fingerprint authentication is successfully performed at the fingerprint registration depot.

2. A mobile communications terminal authentication and settlement system according to claim 1,
wherein the operation panel has a function as a fingerprint sensor, to thereby detect, on a surface of the fingerprint sensor, one of motion of a fingertip and a change in point of applied pressure, and
wherein the operation panel causes one of a cursor and a pointer to move on a display of the mobile communications terminal based on information obtained by the detecting.

3. An authentication and settlement method for an authentication and settlement system in which a mobile communications terminal accesses various websites on an Internet to perform electronic authentication and electronic settlement,
the mobile communications terminal comprising an operation panel that can be used in common for a fingerprint sensor mode and a touch panel mode,
the authentication and settlement system comprising a fingerprint registration depot at which fingerprint information detected by the operation panel is compared with fingerprint registration information registered in advance, to thereby perform fingerprint authentication,
the authentication and settlement method comprising:
connecting the mobile communications terminal to the fingerprint registration depot via the Internet by using the operation panel of the mobile communications terminal in the touch panel mode;
transmitting, to the fingerprint registration depot, the fingerprint information detected by touching the operation panel with a finger;
comparing the fingerprint information with the fingerprint registration information registered in advance at the fingerprint registration depot; and
performing the fingerprint authentication through the comparing, to thereby perform the electronic authentication and the electronic settlement.
